(19) United States
(12) Patent Application Publication
(10) Pub. No.: US 2009/0300049 A1
(43) Pub. Date: Dec. 3, 2009

(54) VERIFICATION OF INTEGRITY OF COMPUTING ENVIRONMENTS FOR SAFE COMPUTING

(75) Inventors: Xinwen ZHANG, San Jose, CA (US); Jean-Pierre Seifert, San Jose, CA (US); Onur Aciicmez, San Jose, CA (US); Afshin Latifi, San Jose, CA (US)

Correspondence Address: Beyer Law Group LLP, P.O. BOX 1687, Cupertino, CA, 95015-1687, US

(73) Assignee: SAMSUNG ELECTRONICS CO., LTD., Suwon City (KR)

(21) Appl. No.: 12/132,541

(22) Filed: Jun. 3, 2008

(51) Int. Cl. G06F 17/00

(52) U.S. Cl. 707/102; 707/104.1; 707/E17.044

(57) ABSTRACT

Improved verification techniques for verification of the integrity of various computing environments and/or computing systems are disclosed. Verifiable representative data can effectively represent verifiable content of a computing environment, thereby allowing the integrity of the computing environment to be verified based on the verifiable representative data instead of the content being represented. Verifiable representative data can effectively include selected portions of the content (e.g., selected content which may be of general and/or specific security interest) and can be generally smaller than the verifiable content it represents. As such, it may generally be more efficient to use the verifiable representative data instead of the content it represents. Verifiable representative data can also be organized. By way of example, unstructured content (e.g., a configuration file written in text) can be effectively transformed based on a scheme (e.g., an XML schema) into a structured text-based content written in a structured language (e.g., XML). Verifiable organized representative data can be organized in accordance with various organizational aspects including, for example, structural, semantics, parameter verification, parameter simplification, and other organizational rules and/or preferences. Organization of verifiable organized representative data can be verified as an additional measure of its integrity, and by in large the integrity of a computing environment and/or system being effectively represented by the verifiable representative data.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information used by a computing system is stored in a in a computer readable memory using a digital or binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known and an Operating System (OS) which provides programmers with an interface used to access these resources and services.

Today, numerous types of computing devices are available. These computing devices widely range with respect to size, cost, amount of storage and processing power. The computing devices that are available today include: expensive and powerful servers, relatively cheaper Personal Computers (PC's) and laptops and yet less expensive microprocessors (or computer chips) provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

In particular, mobile communication devices (e.g., mobile phones) have become extremely popular. Some mobile communication devices (e.g., Smartphones) offer computing environments that are similar to that provided by a Personal Computer (PC). As such, a Smartphone can effectively provide a complete operating system as a standardized interface and platform for application developers. Given the popularity of mobile communication devices, telecommunication is discussed in greater detail below.

Generally, telecommunication refers to assisted transmission of signals over a distance for the purpose of communication. In earlier times, this may have involved the use of smoke signals, drums, semaphore or heliograph. In modern times, telecommunication typically involves the use of electronic transmitters such as the telephone, television, radio or computer. Early inventors in the field of telecommunication include Alexander Graham Bell, Guglielmo Marconi and John Logie Baird. Telecommunication is an important part of the world economy and the telecommunication industry's revenue is placed at just under 3 percent of the gross world product.

Conventional telephones have been in use for many years. The first telephones had no network but were in private use, wired together in pairs. Users who wanted to talk to different people had as many telephones as necessary for the purpose. Typically, a person who wished to speak, whistled into the transmitter until the other party heard. Shortly thereafter, a bell was added for signaling, and then a switch hook, and telephones took advantage of the exchange principle already employed in telegraph networks. Each telephone was wired to a local telephone exchange, and the exchanges were wired together with trunks. Networks were connected together in a hierarchical manner until they spanned cities, countries, continents and oceans. This can be considered the beginning of the public switched telephone network (PSTN) though the term was unknown for many decades.

Public switched telephone network (PSTN) is the network of the world's public circuit-switched telephone networks, in much the same way that the Internet is the network of the world's public IP-based packet-switched networks. Originally a network of fixed-line analog telephone systems, the PSTN is now almost entirely digital, and now includes mobile as well as fixed telephones. The PSTN is largely governed by technical standards created by the ITU-T, and uses E.163/E.164 addresses (known more commonly as telephone numbers) for addressing.

More recently, wireless networks have been developed. While the term wireless network may technically be used to refer to any type of network that is wireless, the term is often commonly used to refer to a telecommunications network whose interconnections between nodes is implemented without the use of wires, such as a computer network (which is a type of communications network). Wireless telecommunications networks can, for example, be implemented with some type of remote information transmission system that uses electromagnetic waves, such as radio waves, for the carrier and this implementation usually takes place at the physical level or “layer” of the network (e.g., the Physical Layer of the OSI Model). One type of wireless network is a WLAN or Wireless Local Area Network. Similar to other wireless devices, it uses radio instead of wires to transmit data back and forth between computers on the same network. Wi-Fi is a commonly used wireless network in computer systems which enable connection to the internet or other machines that have Wi-Fi functionalities. Wi-Fi networks broadcast radio waves that can be picked up by Wi-Fi receivers that are attached to different computers or mobile phones. Fixed wireless data is a type of wireless data network that can be used to connect two or more buildings together in order to extend or share the network bandwidth without physically wiring the buildings together. Wireless MAN is another type of wireless network that connects several Wireless LANs.

Today, several mobile networks are in use. One example is the Global System for Mobile Communications (GSM) which is divided into three major systems which are the switching system, the base station system, and the operation and support system (Global System for Mobile Communication (GSM)). A cell phone can connect to the base system station which then connects to the operation and support station; it can then connect to the switching station where the call is transferred where it needs to go (Global System for Mobile Communication (GSM)). This is used for cellular phones and common standard for a majority of cellular providers. Personal Communications Service (PCS): PCS is a radio band that can be used by mobile phones in North America. Sprint happened to be the first service to set up a PCS. Digital Advanced Mobile Phone Service (D-AMPS) is an upgraded version of AMPS but it may be phased out as the newer GSM networks are replacing the older system.

Yet another example is the General Packet Radio Service (GPRS) which is a Mobile Data Service available to users of Global System for Mobile Communications (GSM) and IS-136 mobile phones. GPRS data transfer is typically charged per kilobyte of transferred data, while data communication via traditional circuit switching is billed per minute of connection time, independent of whether the user has actually transferred data or has been in an idle state. GPRS can be used for services such as Wireless Application Protocol (WAP) access, Short Message Service (SMS), Multimedia Messaging Service (MMS), and for Internet communication services such as email and World Wide Web access. 2G cellular systems combined with GPRS is often described as “2.5G”, that is, a technology between the second (2G) and third (3G) generations of mobile telephony. It provides moderate speed data transfer, by using unused Time Division Multiple Access (TDMA) channels in, for example, the GSM system. Originally there was some thought to extend GPRS to cover other standards, but instead those networks are being converted to use the GSM standard, so that GSM is the only kind of network where GPRS is in use. GPRS is integrated into GSM Release 97 and newer releases. It was originally standardized by European Telecommunications Standards Institute (ETSI), but now by the 3rd Generation Partnership Project (3GPP). W-CDMA (Wideband Code Division Multiple Access) is a type of 3G cellular network. W-CDMA is the higher speed transmission protocol used in the Japanese FOMA system and in the UMTS system, a third generation follow-on to the 2G GSM networks deployed worldwide. More technically, W-CDMA is a wideband spread-spectrum mobile air interface that utilizes the direct sequence Code Division Multiple Access signaling method (or CDMA) to achieve higher speeds and support more users compared to the implementation of time division multiplexing (TDMA) used by 2G GSM networks. It should be noted that SMS can be supported by GSM and MMS can be supported by 2.5G/3G networks.

Generally, a mobile phone or cell phone can be a long-range, portable electronic device used for mobile communication. In addition to the standard voice function of a telephone, current mobile phones can support many additional services such as SMS for text messaging, email, packet switching for access to the Internet, and MMS for sending and receiving photos and video. Most current mobile phones connect to a cellular network of base stations (cell sites), which is in turn interconnected to the public switched telephone network (PSTN) (one exception is satellite phones).

The Short Message Service (SMS), often called text messaging, is a means of sending short messages to and from mobile phones. SMS was originally defined as part of the GSM series of standards in 1985 as a means of sending messages of up to 160 characters, to and from Global System for Mobile communications (GSM) mobile handsets. Since then, support for the service has expanded to include alternative mobile standards such as ANSI CDMA networks and Digital AMPS, satellite and landline networks. Most SMS messages are mobile-to-mobile text messages, though the standard supports other types of broadcast messaging as well. The term SMS is frequently used in a non-technical sense to refer to the text messages themselves, particularly in non-English-speaking European countries where the GSM system is well-established.

Multimedia Messaging Service (MMS) is a relatively more modern standard for telephony messaging systems that allows sending messages that include multimedia objects (images, audio, video, rich text) and not just text as in Short Message Service (SMS). It can be deployed in cellular networks along with other messaging systems like SMS, Mobile Instant Messaging and Mobile E-mal. Its main standardization effort is done by 3GPP, 3GPP2 and Ope Mobile Alliance (OMA).

The popularity of computing systems, especially mobile communication devices, is evidenced by their ever increasing use in everyday life. Accordingly, improved techniques for ensuring their safety would be useful.

### SUMMARY OF THE INVENTION

Broadly speaking, the invention relates to computing environments and computing systems. More particularly, the invention relates to integrity verification techniques for providing safe (or secure) computing environments and computing systems (e.g., a “Trusted” computing environment as will be known by those skilled in the art). The invention, among other things, provides improved verification techniques suitable for verification of the integrity of various computing environments and/or computing systems.

In accordance with one aspect of the invention, verifiable representative data can effectively represent the verifiable content of a computing environment and/or system, thereby allowing the integrity of the computing environment to be verified at least partially based on the verifiable representative data instead of the content being represented. It will be appreciated that the verifiable representative data can effectively include selected portions of the content (e.g., selected content which may be of general and/or specific security interest). In other words, the content being verified can effectively be reduced (e.g., the size of the verifiable representative data can be generally smaller than the size of the content it represents). As such, it may generally be more efficient to use the verifiable representative data instead of content it represents. In accordance with one embodiment of the invention, verifiable representative data can be generated based on a representation of content that can be used to make at least a partial assessment regarding the integrity of a computing environment. The verifiable representative data can include one or more selected portions of the content. The integrity of the verifiable representative data can be verified, thereby allowing the integrity of the computing environment to be verified at least partially based on verification of the integrity of the verifiable representative data.

In accordance with another aspect of the invention, verifiable content of a computing environment and/or system can be organized. In one embodiment, verifiable representative data is generated for the content, based on an organization of the content, as verifiable organized representative data. By way of example, unstructured content (e.g., a configuration file written in text) can be effectively transformed based on a scheme (e.g., a XML schema) into a structured text-based content written in a structured language (e.g., XML language). As such, verifiable organized representative data can be organized in accordance with various organizational aspects including, for example, structural, semantics, parameter verification, parameter simplification, and other organizational rules, requirements and/or preferences.

In accordance with other aspects of the invention, verifiable representative data can be verified in order to assess the integrity of a computing environment and/or computing system. As an example, organization of verifiable organized data can be verified as a measure of its integrity and by in large the integrity of the computing environment and/or system being effectively represented by the verifiable representative data in accordance with yet another aspect of the invention.

The invention can be implemented in numerous ways, including, for example, a method, an apparatus, a computer readable medium, and a computing system (e.g., a computing device). A computer readable medium can include at least executable computer program code stored in a tangible form. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing environment in accordance with one embodiment of the invention.

FIG. 1B depicts a method for generating verifiable data for a computing environment in accordance with one embodiment of the invention.

FIG. 1C depicts a method for verifying the integrity of a computing environment in accordance with one embodiment of the invention.

FIG. 1D depicts a method for verifying the integrity of a computing environment in accordance with another embodiment of the invention.

FIG. 2A depicts a transformation system (or component) suitable for generation of templates of representative verifiable data (or templates) in accordance with one embodiment of the invention.

FIG. 2B depicts a method 250 for generating a template suitable for generation of verifiable data for multiple instances of content associated with a generic content category in accordance with one embodiment of the invention.

FIG. 3 depicts a smart verification system capable of maintaining a set of original verifiable content and a set of verifiable representative data in accordance with one embodiment of the invention.

FIG. 4A depicts an exemplary text-based configuration file which can be transformed to an organized representation in accordance with one embodiment of the invention.

FIG. 4B depicts an organized representation of a text-based configuration file in accordance with one embodiment of the invention.

FIG. 5A depicts a method for generating organized representative data in accordance with one embodiment of the invention.

FIG. 5B depicts a method verification of data representation of content of a computing environment in accordance with another embodiment of the invention.

FIG. 5C depicts a method for verifying the integrity of a computing environment in accordance with one embodiment of the invention.

FIG. 6 depicts a computing system that can use verifiable representative data to verify its integrity in accordance with one embodiment of the invention.

FIG. 7 depicts a computing environment including content that can be represented by verifiable representative data in accordance with one embodiment of the invention.

### DETAILED DESCRIPTION OF THE INVENTION

As noted in the background section, mobile devices are becoming increasingly more popular. Today, wireless networks and mobile communication devices (e.g., Smartphones, cell phones, Personal Digital Assistants) are especially popular. Unfortunately, however, partly because of this popularity, more and more malicious attacks are being directed to wireless networks and mobile communication devices. In addition, recent developments, including relatively new services (e.g., email, file transfer and messaging), and use of common software platforms (e.g., Symbian, Embedded Linux, and Windows CE operating systems) has made mobile communication devices relatively more exposed to malicious attacks. The exposure to malicious attacks could become worse as the wireless networks and mobile communication devices continue to evolve rapidly. Today, wireless and/or portable communication devices (e.g., cell phones, Smartphones) can offer similar functionality as that more traditionally offered by Personal Computers (PCs). As a result, wireless and/or portable communication devices are likely to face similar security problems (e.g., worms, viruses) as those encountered in more traditional computing environments.

Examples of the most notorious threats to cell phones include the Skull, Cabir, and Mabir worms which have targeted the Symbian operating systems. Generally, an MMS-based worm can start attacking initial targets (hit-list) from the network. Each infected phone can scan its contact list and randomly pick up members to deliver a malicious attack in the form of a message. A person can trust an incoming message due to its attractive title or seemingly familiar source and activate the attached file and unwittingly get a phone infected. The infected phone can in turn get other phones infected, and so on. In contrast, a Blue-tooth based worm can take control of a victim phone's Blue-tooth interface and continuously scan for other Blue-tooth-enabled phones within its range. Once a new target has been detected, the worm can effectively connect to other devices and transfers a malicious message to them, and so on.

Taking the cell phone as an example, an active cell phone typically has two security states: susceptible and infected. A susceptible cell phone is not completely protected against worms and may get infected when exposed to a specific worm (e.g., CommWarrior). An infected cell phone can return back to the susceptible state when the user launches a protection (e.g., the CommWarrior patch from F-Secure or Symantec) partly because the cell phone is susceptible to other worm threats. Malware has many other undesirable affects including compromising the privacy of the users.

Today, security of the computing systems (or devices) is a major concern. Generally, it is important that various components of a computing environment and/or computing system maintain their integrity. As such, integrity of a computing component is crucial to ensuring the security (or safety) of a computing system (e.g., a “trusted” device). A secure system (or device) can, for example, be provided as a trusted system (or device) in accordance with the Trusted Computing (TC) principles primarily developed and promoted by the Trusted Computing Group. In Trusted Computing (TC), verification of integrity can be done by taking “Integrity Measurements” of the content. Integrity of various software components, including operating systems and application programs, can be measured (or taken), for example, by using a cryptographic hash function (or hash function). A hash function can generate a fixed-size string (or hash value) for content (e.g., binary code, text files). Hash values can be securely stored as trusted integrity values (or values that are trusted or believed to be safe). The trusted integrity values can be compared to Integrity values subsequently obtained to taken to ensure the integrity of a computing environment and/or computing system. As such, the trusted integrity values can effectively serve as a point of reference where a deviation would indicate that the integrity has been compromised.

Integrity Measurements (IM) are crucial for providing a Trusted Computing (TC) environment. More generally, providing a safe computing environment typically requires verifying the integrity of various components operating in the computing environment. As such, integrity verification techniques are highly useful.

However, conventional integrity verification techniques can be difficult to implement. By way of example, to verify the integrity of a text-based configuration file for configuring a device, the hash value of the configuration file can be taken, but the hash value can change even if minor change (e.g., adding a space) is made to the configuration file. As a result, the integrity values of the device may have to be updated often and possibly provided to other devices or systems that interact with the device. This means that it may be infeasible to verify the integrity of some computing systems, especially those that may operate with limited processing power and/or memory (e.g., mobile and/or embedded devices). Also, conventional integrity verification techniques do not generally allow selective verification of content.

In view of the foregoing, improved integrity verification techniques are needed and would be very useful.

It will be appreciated that the invention, among other things, provides improved verification techniques suitable for verification of the integrity of various computing environments and/or computing systems.

In accordance with one aspect of the invention, verifiable representative data can effectively represent the verifiable content of a computing environment and/or system, thereby allowing the integrity of the computing environment to be verified at least partially based on the verifiable representative data instead of the content being represented. It will be appreciated that the verifiable representative data can effectively include selected portions of the content (e.g., selected content which may be of general and/or specific security interest). In other words, the content being verified can effectively be reduced (e.g., the size of the verifiable representative data can be generally smaller than the size of the content it represents). As such, it may generally be more efficient to use the verifiable representative data instead of content it represents. In accordance with one embodiment of the invention, verifiable representative data can be generated based on a representation of content that can be used to make at least a partial assessment regarding the integrity of a computing environment. The verifiable representative data can include one or more selected portions of the content. The integrity of the verifiable representative data can be verified, thereby allowing the integrity of the computing environment to be verified at least partially based on verification of the integrity of the verifiable representative data.

In accordance with another aspect of the invention, verifiable content of a computing environment and/or system can be organized. In one embodiment, verifiable representative data is generated for the content, based on an organization of the content, as verifiable organized representative data. By way of example, unstructured content (e.g., a configuration file written in text) can be effectively transformed based on a scheme (e.g., a XML schema) into a structured text-based content written in a structured language (e.g., XML language). As such, verifiable organized representative data can be organized in accordance with various organizational aspects including, for example, structural, semantics, parameter verification, parameter simplification, and other organizational rules, requirements and/or preferences.

In accordance with other aspects of the invention, verifiable representative data can be verified in order to assess the integrity of a computing environment and/or computing system. As an example, organization of verifiable organized data can be verified as a measure of its integrity and by in large the integrity of the computing environment and/or system being effectively represented by the verifiable representative data in accordance with yet another aspect of the invention.

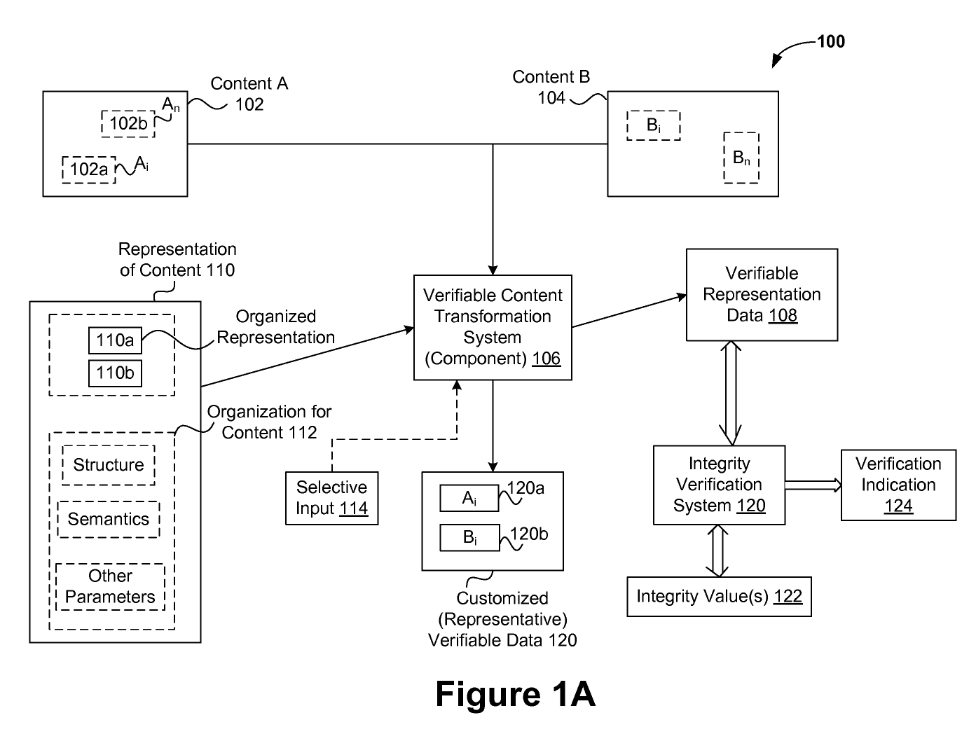

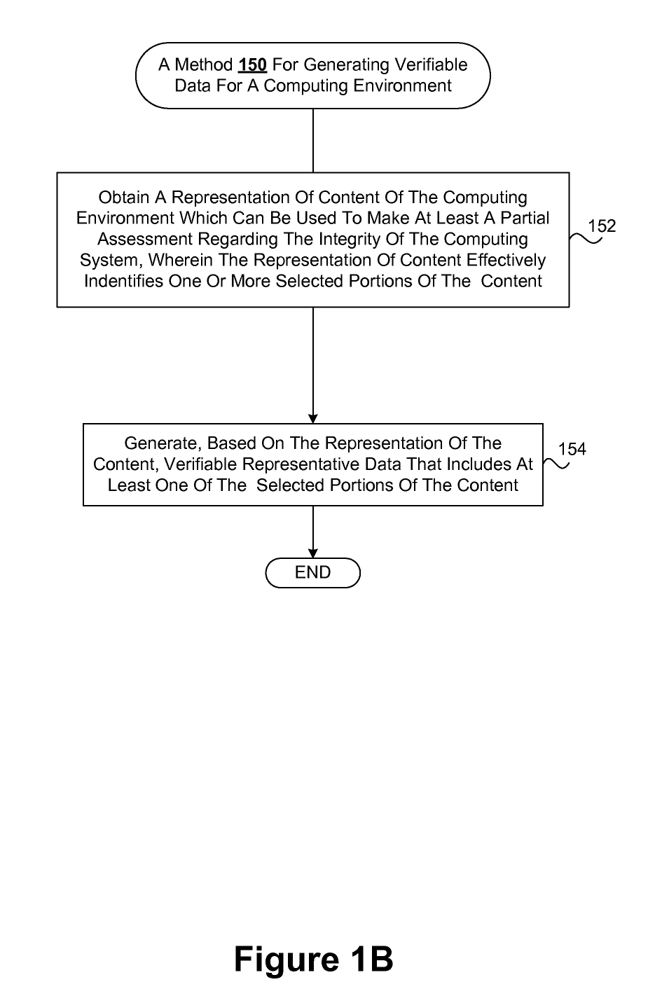

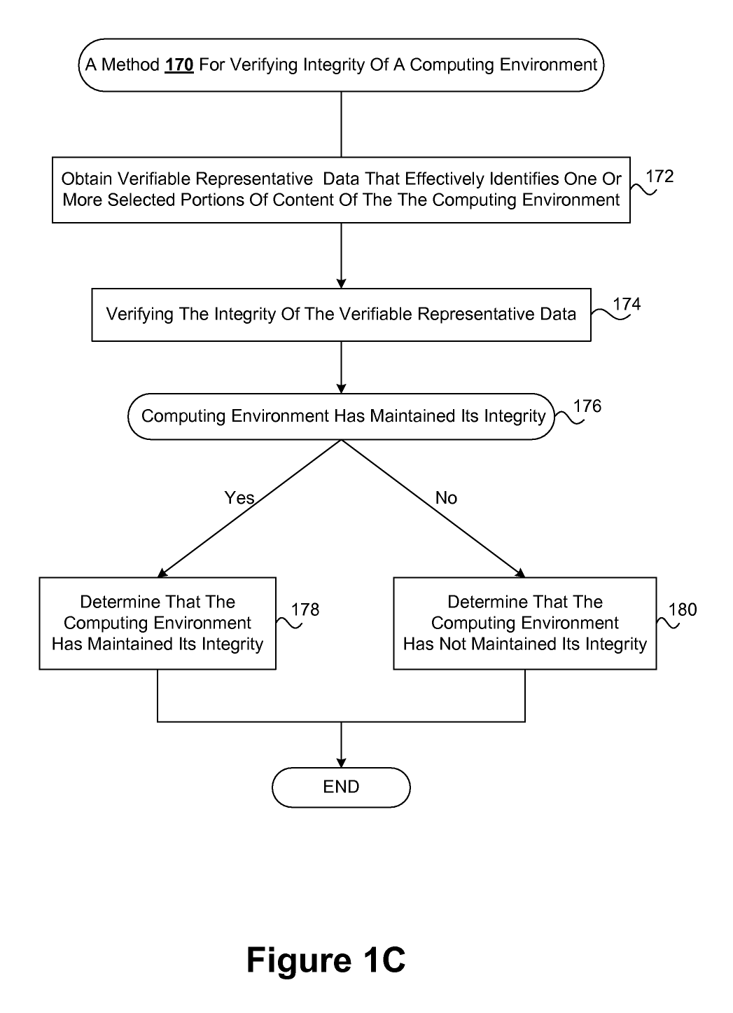

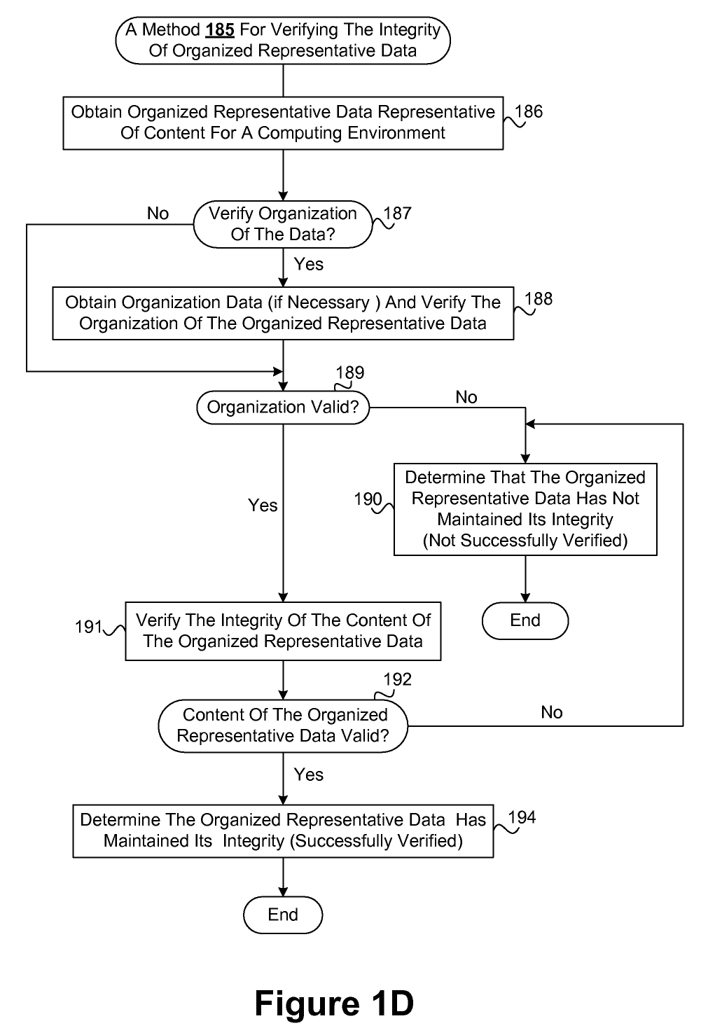

Embodiments of these aspects of the invention are discussed below with reference to FIGS. 1A-7. However, those skilled in the art will readily appreciate that the detailed description given herein with respect to these figures is for explanatory purposes as the invention extends beyond these limited embodiments.

FIG. 1A depicts a computing environment 100 in accordance with one embodiment of the invention. The computing environment 100 can, for example, represent a computing environment provided for a computing system and/or computing device (e.g., a Personal Computer (PC), a mobile phone). Referring to FIG. 1A, content A and B (102 and 104) can represent verifiable content of the computing environment 100. Typically, the verifiable content A and B can be verified to make at least a partial assessment regarding the integrity of the computing environment 100. As such, the content A and/or B can, for example, be one or more files, one or more text-based and/or text files, one or more configuration files, one or more executable scripts, configurable programs, and so on.

Referring back to FIG. 1A, a verifiable content transformation system (component) 106 can effectively transform the content A and/or B (102 and 104) into verifiable representative data 108. More particularly, the verifiable content transformation system 106 can obtain a representation of the content 110 for the content A and/or B (102 and 104). Generally, then representation of content (or content representation) 110 can effectively identify one or more portions of content of the computing environment 100 (e.g., content A and/or content B (102 and 104). By way of example, representation of content 110 can effectively represent content A (102) and, as such, effectively identify one or more of the content portions Aᵢ-Aₙ (102a and 102b) of the content A (102). It should be noted that the representation of content 110 can effectively represent more than one individual content component (e.g., represent both content A and B) of the computing environment. In any case, representation of content 110 can effectively identify one or more portions of content (e.g., 110a, 110b) which have been selected for verification (selected content portions). The verifiable content transformation system 106 can obtain the selected content portions identified by the representation of content 110 and generate based on the selected content portions (e.g., 110a and 110b) verifiable representative data 108. Typically, the verifiable presentation data 108 effectively includes the selected content portions identified by the representation of content 110. It will be appreciated that the verifiable representative data 108 can effectively represent content of the computing environment 100, thereby allowing the integrity of the computing environment 102 to be verified at least partly based on the verification of the verifiable representative data 108.

It should be noted that the selected content portions of the representation of content need not include all of the content. As such, representation of content 110 need not represent all the content of the content A (102) in order to effectively represent the content A. As a result, the verifiable representation data 108 can be a relatively smaller size than the actual content being represented (e.g., content A and/or B), thereby, among other things, allowing verification of data to be performed more efficiently.

It will also be appreciated that the representation of content 110 can effectively include an organization for content (or content organization) 112 being represented. As depicted in FIG. 1a, the organization for content 112 can, for example, include structure (e.g. structural data), semantics (e.g., data pertaining to semantics used for an organized representation), and other organizational rules, policies and/or parameters (e.g., one or more parameters representing a simplified version of original parameters of the content A and/or B). As such, the representation of content 110 can include and/or be an organized representation (e.g., a scheme, an organizational scheme, an organizational map, an organizational blue print, a schema, a conceptual schema, a conceptual data model).

As an organized representation, the representation of content 110 can, for example, include a plurality of selected content portions from one or more of the plurality of content (or content components) depicted in FIG. 1A, namely content A and content B (102 and 104). Moreover, the selected content portions can be arranged in accordance with an arrangement effectively defined by the organization representation of content 110.

The verifiable content transformation system 106 can be operable to generate the verifiable representative data 108 based on input (or selected input) 114. In other words, the verifiable transformation system 106 can effectively allow the verifiable representative data 108 to be customized based on input 114 that can effectively select one or more content portions that have been identified by the representation of content 110. As such, customized verifiable data 120 can, for example, include the content portion 120a associated with a content portion 110a of the representation of content 110 which is selected from the content A (102) and/or a content portion 120b associated with a content portion 110b selected from the content B (104).

As noted above, the verifiable content transformation system 106 can obtain the representation of content 110. By way of example, the verifiable content transformation system 106 can be operable to receive, identify, determine, and/or define the representation of content 110. Generally, one or more portions of content (or content portions) can be selected from content (e.g., content A, content B) in order to effectively define the representation of content 110. The one or more content portions can, for example, be selected as one or more security related portions of content (e.g., content of a security interest, such as, for example, one or more specific parameters in a configuration file), thereby allowing the verifiable representation 108 to include content that is of security interest, and as such, can be verified to ensure the integrity of content that is of general and/or specific security interest. As another example, representation of content 110 can be defined such that one or more portions of content that are susceptible to change but not of relative security importance are not identified, thereby allowing generating verifiable representative data 108 which is less likely to be changed as a result of change to content which is of a relatively lesser security importance.

Those skilled in the art will readily appreciate that the verifiable content transformation system (or component) 106 can, for example, be implemented using one or more hardware and/or software components. By way of example, the verifiable content transformation system (or component) 106 can be provided a computer program code stored in a computer readable medium (not shown) and executed by one or more processors (not shown) provided for a computing system or device (not shown), such as, for example, a Personal Computer (PC), a laptop, a mobile and/or smart phone, and so on.

Generally, the integrity of the verifiable representation data 108 can be verified. Referring to FIG. 1A, an integrity verification system 120 can generate one or more integrity values 122 for the verifiable representation data 108 and effectively use them to ensure the integrity of the computing environment 100. By way of example, the integrity verification system 120 can take a current measurement of the verifiable representation data 108 (or current integrity value) at a given time. The current measurements can be compared to an expected integrity value (or integrity value known or believed to be safe (e.g., trusted). Generally, the integrity verification system 120 can effectively provide a verification indication 124 of whether the verifiable representation data 108 has maintained its integrity or not. Moreover, it will be appreciated that the integrity verification system 120 can be operable to verify the organization of the verifiable representation data 108 when it is provided as organized verifiable representation data in accordance with the invention.

FIG. 1B depicts a method 150 for generating verifiable data for a computing environment in accordance with one embodiment of the invention. Method 150 can, for example, be performed by the verifiable content transformation system (component) 106 shown in FIG. 1A to generate verifiable data. The verifiable data can effectively represent verifiable content of a computing environment and/or computing system, and be verified in order to make at least a partial assessment regarding the integrity of the computing environment and/or computing system.

Referring to FIG. 1B, initially, a representation of content of the computing environment is obtained (152). It should be noted that the typically the content being represented can be used to make at least a partial assessment regarding the integrity of the computing system. Moreover, the representation of content can effectively identify one or more selected portions of the content. After obtaining (152) the representation of the content, verifiable representative data is generated (154) based on the representation of the content. Generally, the verifiable representative data can effectively represent the content and can include at least one of the selected portions of the content effectively identified by the representation of content. It should be noted that the integrity of the verifiable representative data can be verified, thereby allowing the integrity of a computing environment and/or computing system to be verified at least partly based on the verification of the integrity of the verifiable representative data. Generally, since the verifiable representative data can include content of the computing environment, the integrity of the computing environment can be verified at least partly based on the verification of the integrity of the verifiable representative data. The method 150 ends after the verifiable representative data is generated (154).

FIG. 1C depicts a method 170 for verifying the integrity of a computing environment in accordance with one embodiment of the invention. Method 170 can, for example, be used to verify the integrity of a computing device (e.g., a Personal Computer (PC), a mobile phone). Referring to FIG. 1C, initially, verifiable representative data is obtained (172). Typically, the verifiable representative data can effectively represent content that can be used to make at least a partial assessment regarding the integrity of the computing environment. The verifiable representative data can effectively identify one or more selected portion on the content of the computing environment. After the verifiable representative data is obtained (172), the integrity of the verifiable representative data is verified (174). Accordingly, it is determined (176), based on the verification of the integrity of the verifiable representative data, whether the computing environment has maintained its integrity. As such, if the integrity of the verifiable representative data is successfully verified (176), it can be determined (178) that computing environment has maintained its integrity. On the other hand, if it is determined (176) that the integrity of the verifiable representative data is not successfully verified (176), it can be determined (180) that the computing environment has not maintained its integrity. The method 170 ends after a positive determination (178) or a negative determination (180) regarding the integrity of the computing environment.

As noted above, representation of verifiable content can include an organization for content, allowing organized verifiable representative data to be generated in accordance with one aspect of the invention. It will be appreciated that the organization of the variable representative data can be verified as a measure of the integrity of the content.

To further elaborate, FIG. 1D depicts a method 185 for verifying the integrity of a computing environment in accordance with another embodiment of the invention. Method 185 can, for example, be used to verify the integrity of various components (e.g., applications, library modules, system modules, configuration files) of a computing device (e.g., a Personal Computer (PC), a mobile phone). Referring to FIG. 1D, initially, organized representative data is obtained (186). The organized representative data can represent verifiable content of a computing environment, and as such, the integrity of the organized representative data can be verified (i.e., the organized representative data can be verified).

Referring back to FIG. 1D, after obtaining (186) of the organized representative data, it is determined (187) whether to verify the organization of the organized representative data. Those skilled in the art will appreciate that the determining (187) can represent a design choice and/or ban be made, based on various criteria (e.g., type of the data, receiving an indication or input effectively requesting verification of the organization). In any case, if it is determined (187) to verify the organization of data, the organization of data can be verified (188). By way of example, various organizational aspects including, structure, semantics and/or organizational rules (e.g., whether a parameter is within a defined acceptable range) can be verified. It should be noted that the organizational aspects can, for example, be defined for a general or broad class of data (e.g., data provided in a particular structured language, a data category) and/or defined specifically for a specific instance of the organized representative data. As such, it may be necessary to obtain the organizational data associated with one or more organizational aspects in order to verify the organization of a particular instance of organized representative data.

In any case, based on the verification (188) of the organization of the organized representative data, it can be determined (189) whether the organization is valid. As such, if it is determined (189) that the organization of the organized representative data is valid, it is determined (190) that the organized representative data has not maintained its integrity. In other words, it is determined (190) that the organized representative data has not been successfully verified, and the verification method 185 ends. However, if it is determined (191) that the organization of the organized representative data is valid, the verification method 185 proceeds to verify (191) the integrity of the content of the organized representative data. By way of example, an integrity measurement of the content can be taken (e.g., a hash or digest value can be calculated) and compared with an excepted integrity value (e.g., a trusted integrity value). Accordingly, it can be determined (192) whether the content of the organized representative data is valid. If it determined (192) that the organized representative data is not valid, it is determined (190) that the organized representative data has not maintained its integrity and the verification method 185 ends. On the other hand, if it is determined (192) that the organized representative data is valid, it is determined (194) that the organized representative data has maintained its integrity. In other words, the integrity of the organized representative data can be successfully verified before the verification method 185 ends.

As noted above, a verifiable content transformation system (or component) 106 (shown in FIG. 1A) can be operable to effectively generate customized verifiable (representative) data that can effectively represent verifiable content of a computing environment. It will also be appreciated that a system (or component) can be provided to effectively generate content which can be used to generate verifiable representative data (or a template) for multiple instances of a generic content category.

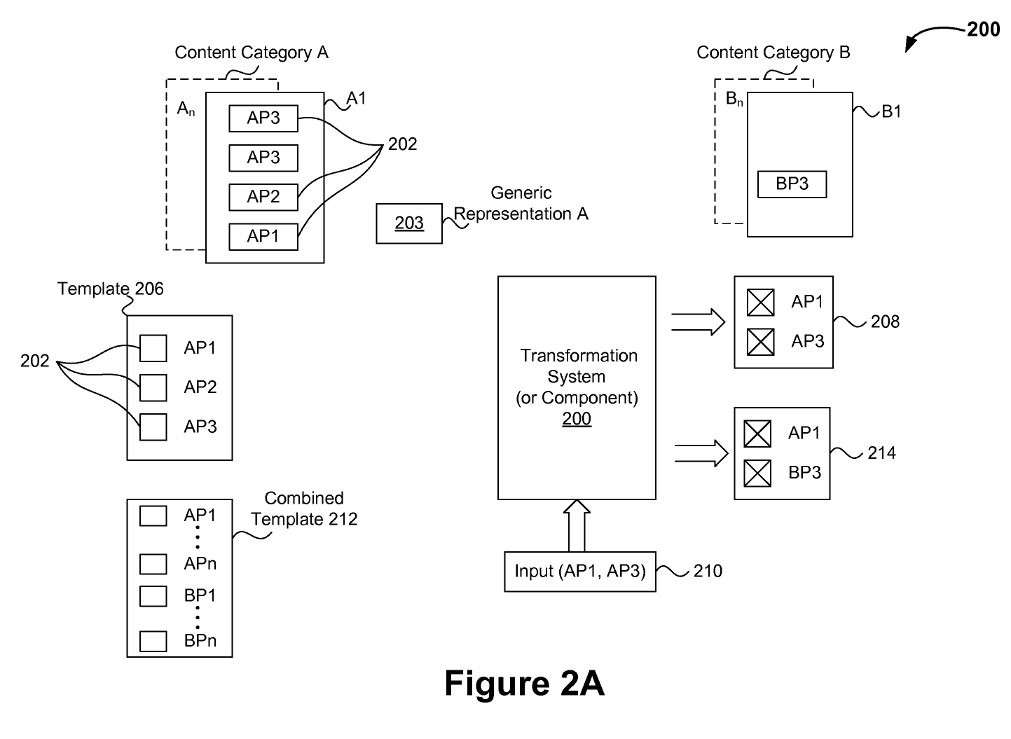

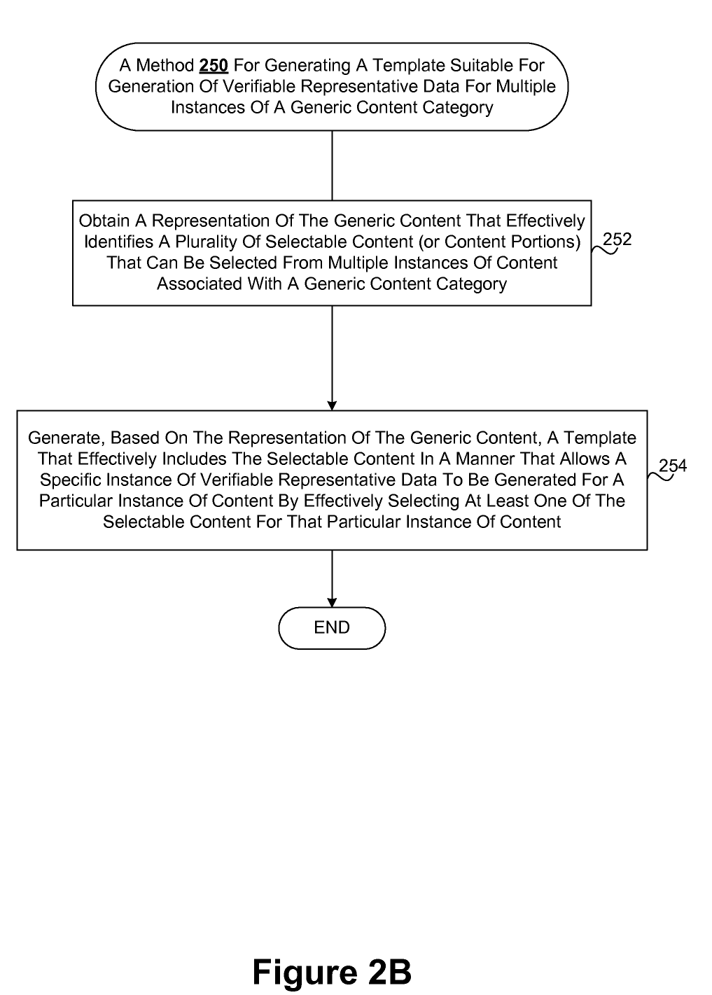

To further elaborate, FIG. 2A depicts a transformation system (or component) 200 suitable for generation of templates of representative verifiable data (or templates) in accordance with one embodiment of the invention. A template of representative verifiable data (or template) can be used to generate verifiable representative data for multiple instances of a generic content category. Referring to FIG. 2A, multiple instances of a generic content category A are depicted as content A₁-Aₙ. A generic content category A can, for example, represent multiple instances of a configuration file that may exist in a computing environment or computing system. As such, a generic content category can, for example, be broadly defined to include all configuration files, or more narrowly defined to include all network configuration files, or even more narrowly defined to be all instances of a particular file (e.g., a “http.config” configuration file). Generally, a template can be suitable for generating verifiable representative data for multiple computing environments and/or computing systems.

Referring back to FIG. 2A, the transformation system (or component) 200 can be operable to effectively obtain a representation of a generic content category 203 (e.g., generic representation A). Generally, a representation of a generic content category can effectively include a plurality of selectable content and/or content portions that can be used to effectively represent multiple instances of the generic content category. By way of example, a generic representation 203 of the generic category A can include a plurality of selectable content portions 202 which are useful for representing multiple instances of the generic content category A. In other words, one or more content portions 202 can be selected and used to represent a particular instance of the generic content category A. As such, the selectable content portions 202 can, for example, include one or more common parameters in a set of configuration files. The common parameters can, for example, be selected as one or more security parameters that are of general and/or specific security interest. It should be noted that the transformation system 200 can be operable to effectively define the generic representation 203 of the generic content. As will be appreciated by those skilled in the art, the transformation system 200 can, for example, be provided as an automated tool which is programmed to effectively identify the content portions 202 for the generic content category A. Such an automated tool can, for example, be programmed to receive multiple files, and search their content in order to identify and extract various security related content portions (e.g., parameters, elements) from the files. As will be appreciated text-based content can be extracted and transformed into structural text (e.g., text provided in a structural language).

In any case, transformation system 200 can effectively generate based on the generic representation 203 of the generic content category A, a template 206 representative of the generic content category A. The template 206 can effectively include the selected content (or content portions) 202 in a manner that allows a specific instance of verifiable representative data 208 to be generated for a particular instance of content by effectively selecting one or more of the selectable content portions 202. The specific instance of verifiable representative data 208 can, for example, be generated based on input 210 (e.g., input provided by a person in order to select selectable content from the template 206 for the specific instance of verifiable representative data 208). As another example, the transformation system 200 can be operable (e.g., programmed as an automated tool) to automatically generate the specific instance of verifiable representative data 208 for a particular situation, user and/or device. It should be noted that the generic representation 203 can also be defined based on input (e.g., input provided by a person).

Generally, the transformation system 200 can be operable to receive existing content (e.g., configuration files which are already in existence) and generate one or more templates that can be used to generate verifiable representative data suitable for assessing the integrity of a computing environment and/or computing system. It should also be noted that the transformation system 200 can also be operable to generate a template which is representative of multiple generic content categories. Referring to FIG. 2A, a combined template 212 can effectively represent the generic content categories A and B. As such, the combined template 212 can effectively include selectable content portions associated with both of the generic content categories A and B. As a result, a specific instance of verifiable representative data 214 can effectively be generated based on content selected across multiple generic content categories. As such, it is possible to, for example, select one or more parameters from a first type of configuration file and select one or more other parameters from a second type of configuration file and effectively combine them to provide representation or sample of the configuration files of the computing environment and/or computing system.

FIG. 2B depicts a method 250 for generating a template suitable for generation of verifiable data for multiple instances of content associated with a generic content category in accordance with one embodiment of the invention. Method 250 can, for example, be used by the transformation system (or component) 200 depicted in FIG. 2A. Referring to FIG. 2B, initially, a representation of a generic content category is obtained (252). The representation can effectively identify a plurality of selectable content and/or content portions that can be used to effectively represent multiple instances of a generic content category. After obtaining (252) of the generic content category, a template is generated (254), based on the representation of a generic content. The template can effectively include the plurality of selectable content and/or content portions in a manner that allows a specific instance of verifiable organized data to be generated for a particular instance of the generic content category using the template by effectively selecting one or more of the selectable content and/or content portions for verification of the particular instance of content. The method 250 ends after the template has been generated (254).

As noted above, verifiable representative data can be generated for content that may already exist (e.g., existing configuration files) in a computing environment or computing system. The verifiable representative data can be verified instead of the content it represents (original content). As such, verifiable representative data can effectively replace the original content or can be provided in addition to the original content existing in a computing environment. By way of example, verifiable representative data representing an original configuration file can effectively be used as a new configuration file and/or used to generate new configuration files that can be maintained in addition to or in place of the original configuration files.

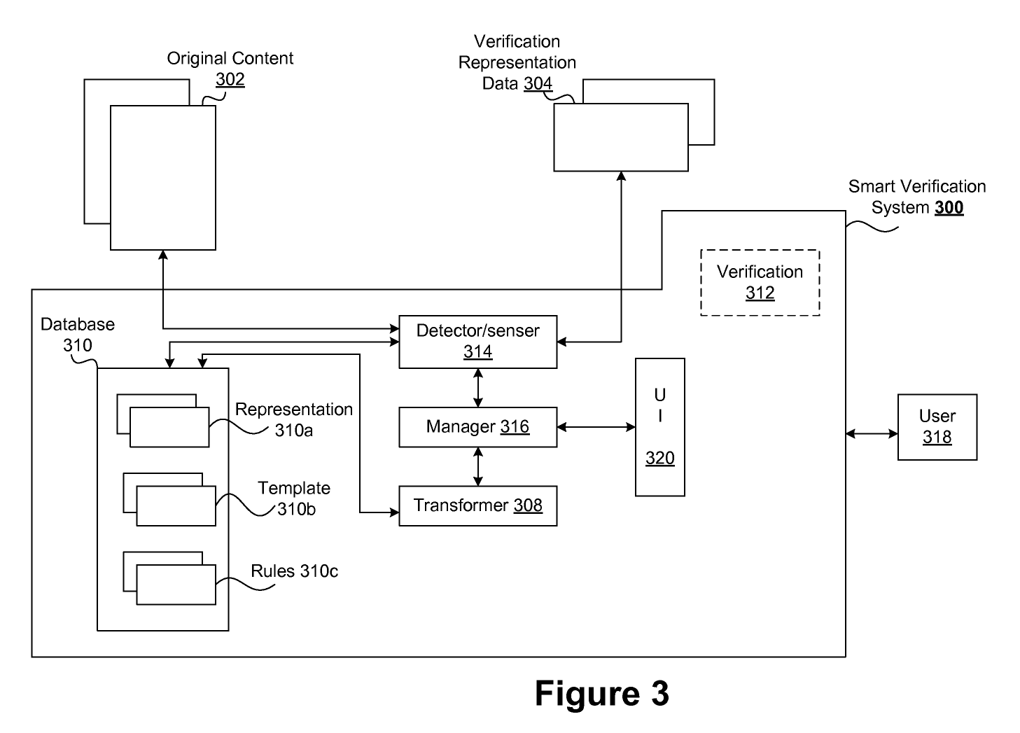

To further elaborate, FIG. 3 depicts a smart verification system 300 capable of maintaining a set of original verifiable content 302 and a set of verifiable representative data 304 in accordance with one embodiment of the invention. Referring to FIG. 3, a transformer 308 can effectively use the representation data 310a, templates 310b, and/or rules 310c stored in a database 310 in order to generate the verifiable representative data 304 for verification. The verification may be performed by a verification component 312. As shown in FIG. 3, the smart verification system 300 can also include a detector/sensor component 314. The detector/sensor component 314 can be operable to detect a change in the original content and communicate it with the manager 316. The manager 316 can be operable to determine whether the change in the original content would necessitate generating new and/or updating existing verifiable representative data 304. By way of example, a change in a security parameter in a configuration file may cause generation of updated verifiable representative data if the security parameter is to be included in the verifiable representative data 304. Also, a change in the representation data 310a, templates 310b and/or rules 310 can result in generation of new verifiable representative data 304 and/or updating existing verifiable representative data 304. In general, any operation including adding, removing and changing a parameter may cause creating new verifiable representative data and/or or updating existing verifiable representative data 304. Changes to the database 310 may, for example, by made by a user 318 (e.g., a person) that interacts with a User Interface (UI) 320. The smart verification system 300 can also be operable to allow the user 318 (e.g., an administrator, an administrative application program) to create new verifiable representative data 304 and/or edit existing verifiable representative data 304.

As noted above, verifiable representative data can be provided as organized data (organized verifiable representative data). In particular, it will be appreciated that text-based content and/or textual content can be effectively transformed using a scheme (e.g., configuration scheme such as an XML configuration scheme). The scheme can, for example, be associated with a structured language (e.g., a “markup language”, such as “Extensible Markup Language”).

As generally known in the art, a markup language can be an artificial language using a set of annotations to text that describe how text is to be structured, laid out, and/or formatted. A well-known example of a markup language in use today in computing is HyperText Markup Language (HTML), one of the protocols of the World Wide Web. HTML follows some of the markup conventions used in the publishing industry in the communication of printed work between authors, editors, and printers.

Another markup language that is now widely used is XML (Extensible Markup Language). XML has been developed by the World Wide Web Consortium (W3C). XML allowing users to create “tags” as needed (hence “extensible”) and then describing the tags and their permitted uses. As such, XML can be classified as an extensible language because it allows its users to define their own elements.

As an Extensible Markup Language, XML can be a general-purpose specification for creating custom markup languages. It is classified as an extensible language because it allows its users to define their own elements. XML can facilitate the sharing of structured data across different information systems, particularly via the Internet, and it can be used both to encode documents and to serialize data.

Broadly speaking, an XML schema can be a description of a type of XML document, typically expressed in terms of constraints on the structure and content of documents of that type, above and beyond the basic syntax constraints imposed by XML itself. An XML schema provides a view of the document type at a relatively high level of abstraction. There are languages developed specifically to express XML schemas. The Document Type Definition (DTD) language, which is native to the XML specification, is a schema language that is of relatively limited capability, but that also has other uses in XML aside from the expression of schemas.

XML Schema is one of several XML schema languages. It was the first separate schema language for XML to achieve Recommendation status by the W3C. Like all XML schema languages, XML Schema can be used to express a schema: a set of rules to which an XML document must conform in order to be considered ‘valid’ according to that schema. However, unlike most other schema languages, XML Schema was also designed with the intent that determination of a document's validity would produce a collection of information adhering to specific data types.

The process of checking to see if an XML document conforms to a schema can be called validation, which can be separate from XML's core concept of syntactic well-formedness. All XML documents must be well-formed, but it is not required that a document be valid unless the XML parser is “validating,” in which case the document is also checked for conformance with its associated schema. DTD-validating parsers are most common, but some support W3C XML Schema or RELAX NG as well.

Documents can be considered “valid” if they satisfy the requirements of the schema with which they have been associated. These requirements typically include constraints, such as, elements and attributes that must/may be included, and their permitted structure, the structure is specified by a regular expression syntax, how character data is to be interpreted (e.g., a number, a date, a URL, a Boolean). As known in the art, XML Schema validations can be effectively performed using specialized parsers like JAXB or SAX. XML schema languages include: Document Definition Markup Language (DDML), Document Schema Definition Languages (DSDL), Document Structure Description (DSD), Document Type Definition (DTD), Namespace Routing Language (NRL), RELAX NG and its predecessors RELAX and TREX, SGML, Schema for Object-Oriented XML (SOX), Schematron, XML-Data Reduced (XDR), and XML Schema (W3C) (WXS or XSD).

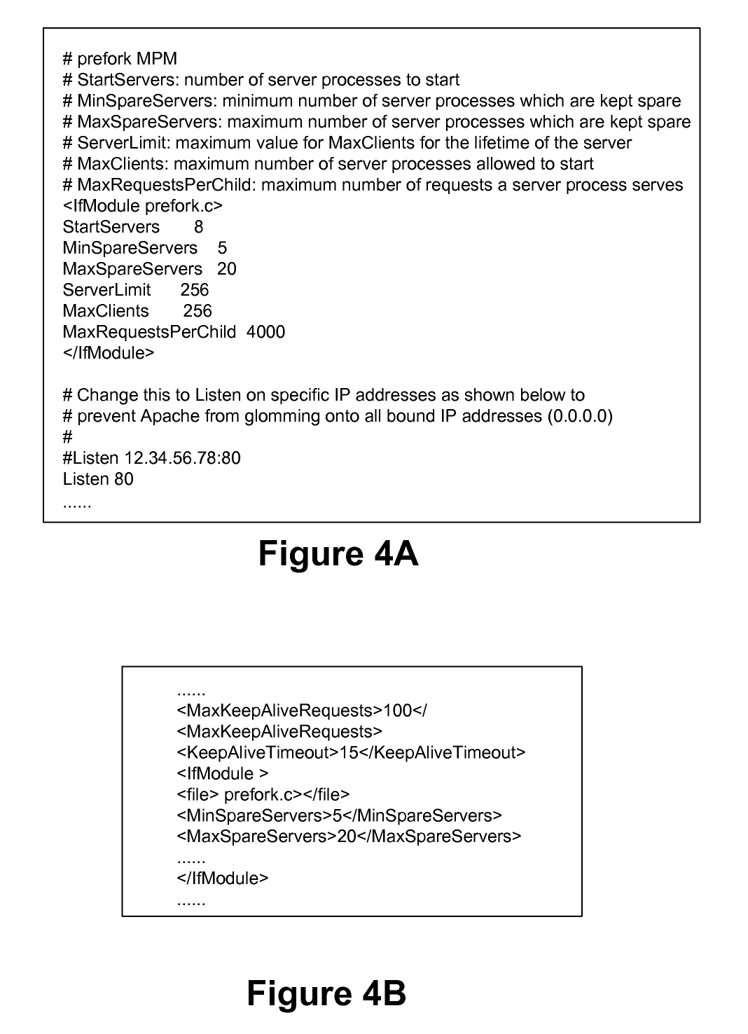

To further elaborate, FIG. 4A depicts an exemplary text-based configuration file which can be transformed to an organized representation in accordance with one embodiment of the invention. The exemplary text-based configuration file can, for example, be provided for a Linux-based computing environment. FIG. 4B depicts an organized representation of the text-based configuration file (depicted in FIG. 4A) in accordance with one embodiment of the invention. It will be appreciated that a configuration file, such as, the configuration shown in FIG. 4A can be logically viewed as an assignment of a set of values (e.g., 100) to a respective set of variables (e.g., “MaxKeepAliveRequests”) which can be predefined and/or known prior to transformation of the configuration file. As such, a scheme can be defined for a configuration file to allow transformation of the text-based content into organized representative data. In particular, for the exemplary configuration file depicted in FIG. 4A, a scheme based on the XML structured or mark up language can be used. Those skilled in the art will know that other mechanisms including, for example, a mechanism based on “Windows Registry” can also be used for the transformation process. Further, additional organizational/validation rules can be defined. For example, a relatively wide parameters range (e.g., 1-300) can be effectively reduced to simpler range (1-3), where a more complex parameter value (e.g., 287) can be effectively transform to a relatively simpler value (e.g., 2).

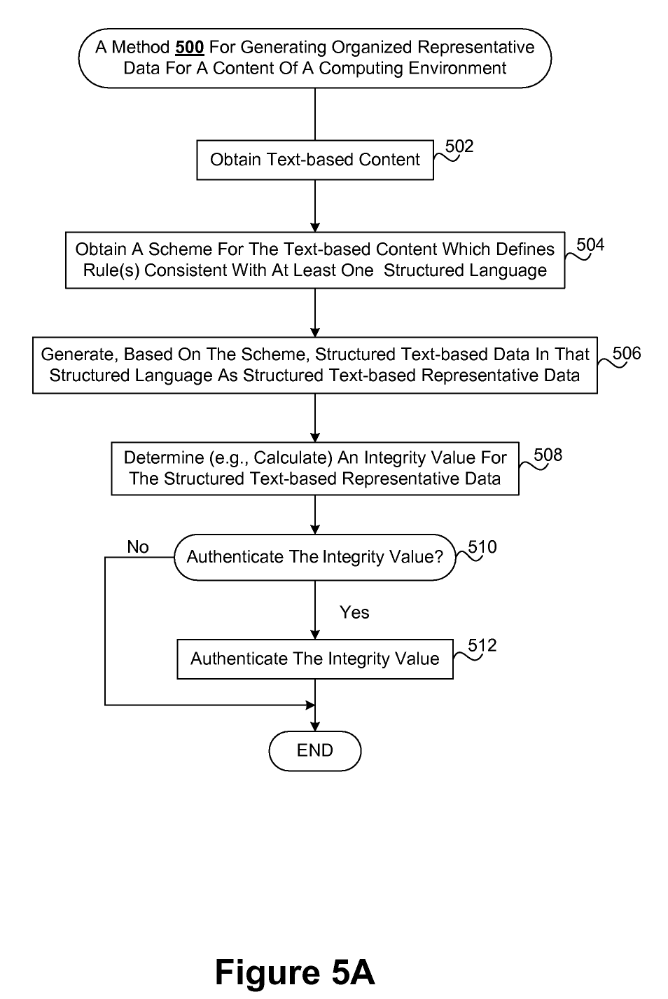

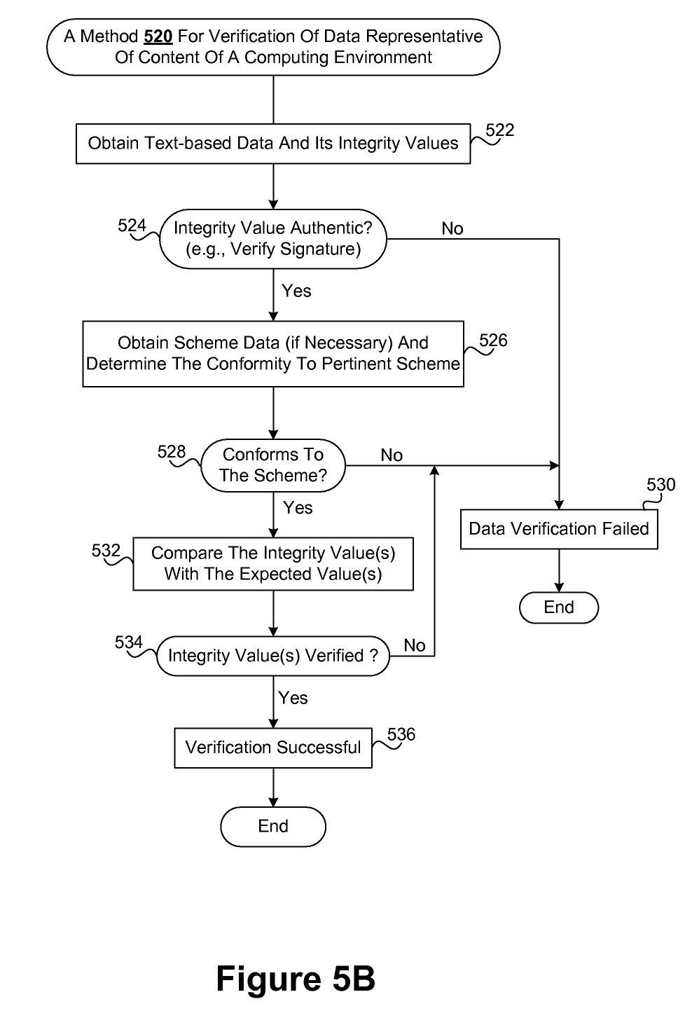

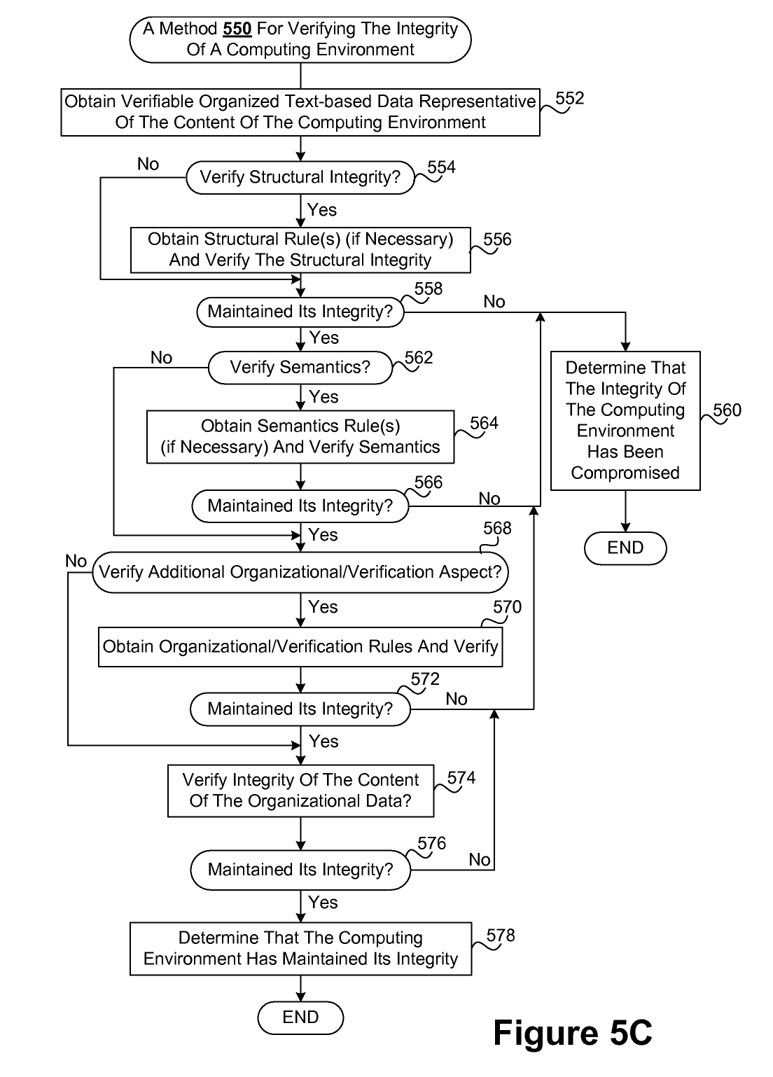

FIG. 5A depicts a method 500 for generating organized representative data in accordance with one embodiment of the invention. The organized representative data can effectively represent verifiable text-based content of a computing environment. The organized representation data can be verifiable and verified to assess the integrity of the computing environment Method 500 can, for example, be performed by the smart verification system 300 (depicted in FIG. 3) to generate organized representative data for text-based content.

Referring to FIG. 5A, initially, text-based content is obtained (502). Next, a scheme for the text-based content is obtained (504). The scheme (e.g., XML schema) can effectively define one or more rules for providing data consistent with at least one structured language (e.g., XML structured language). As such, the scheme can at least define a structure (e.g., define one or more structural rules) for providing data (or content) in a particular structured language. Accordingly, based on a scheme associated with a structured language, structured text-based data can be generated (506) in that structured language. The structured text-based data can effectively represent text-based content and can be generated as verifiable data (verifiable structured text-based representative data). It should be noted that the text-based content can include unstructured text (e.g., configuration files written in text) which is effectively transformed to structured text-based data.

After, generating (506) of the structured text-based data, an integrity value can be determined (508) for the structured text-based data. In addition, it can be determined (510) whether to “authenticate” the integrity value in order to allow verification of its authenticity. Those skilled in the art will appreciate that the determination (510) can present a design choice and/or can be made based on various criteria including, for example, type of data, the desired level of general security, an indication and/or input received in connection with the text-based content. In any case, if it is determined (510) to authenticate integrity value, one or more authentication techniques can be used to effectively authenticate the integrity value. By way of example, structured text-based representative data can be digitally signed and the signature can be subsequently verified to effectively authenticate the integrity value. The method 500 ends after authenticating (512) of the integrity value or directly after a determination (510) not to authenticate the integrity value.

FIG. 5B depicts a method 520 verification of data representation of content of a computing environment in accordance with another embodiment of the invention. Referring to FIG. 5B, initially, text-based data (or content), and one or more integrity values for the text-based data are obtained (522). Typically, the text-based data is expected to be in a structured language. The integrity value(s) can, for example, represent current (or recent) measurement taken for the text-based data. Generally, the integrity value(s) can be expected to authentic. As such, it can be determined (524) whether the one or more integrity values are authentic. By way of example, the signature of a digitally signed integrity value(s) can be verified.

Accordingly, if it is determined (524) that an integrity value is not authentic, verification of data fails (526), and the verification method 520 subsequently ends. On the other hand, if it is determined (524) that the one or more integrity values of the text-based data are authentic, it is determined (526) whether the text-based data conforms to the particular scheme. To make this determination (526), it may be necessary to obtain general schema data for a structured language and/or specific schema defined for the text-based data. In any case, if it is determined (528) that the text-based content does not conform to scheme of the structured language, verification of data fails (526), and the verification method 520 ends. However, if it is determined (528) that the text-based content conforms to the scheme, the verification method 520 can proceed to compare (532) the one or more integrity values with one or more expected values (e.g., one or more trusted values securely stored). As such, the one or more integrity values can be verified (534). Accordingly, the text-based content can be successfully verified (536) or fail (526) based on the comparison (532) of the one or more integrity values before the verification method 520 ends.

FIG. 5C depicts a method 550 for verifying the integrity of a computing environment in accordance with one embodiment of the invention. The verification method 550 can, for example, be performed by a computing system or device. Referring to FIG. 5C, initially, verifiable organized text-based data representative of the content of the computing environment is obtained (552). The verifiable organized text-based data can, for example, be provided in a structured language (e.g., XML language). Generally, the organized text-based data can be provided in accordance with structural, semantics and/or other organizational aspects. Moreover, the organizational aspects of the text-based data can be verified. In other words, it can be determined whether the organized text-based data adheres to one or more organizational rules, requirements and/or preferences. Accordingly, it can be determined (554) whether to verify the structural integrity of the organized data. Those skilled in the art will appreciate that the determination (554) can represent a design choice and/or can be made based on various criteria including, for example, the nature or type of the data being verified, preferences set for a device or system, input and/or indication received, and so on. In any case, if it is determined (554) to verify the structural integrity of the organized text-based data, one or more structural rules can be obtained, if necessary, and the structural integrity of the organized text-based data can be verified (556). In other words, it can be determined whether the structure of the organized text-based data adheres to one or more structural rules (e.g., rules of a particular structured language and/or rules specifically defined for the data being verified.

If the structural integrity of the organized text-based data is not successfully verified (558), it is determined (560) that the integrity of the computing environment has been compromised, and the verification method 550 ends. On the other hand, if it is determined (558) that the organized text-based data has maintained its structural integrity, it is determined (562) whether to verify the semantics of the organized text-based data. The verification method 550 can proceed in a similar manner as noted above, to obtain one or more semantics rules (if necessary) and verify the semantics of the organized text-based data to determine (566) whether it has maintained its integrity. Additional organizational/verification aspects can be considered (568) and additional rules can be obtained (if necessary) and used to effectively verify (570) the organization of the organized data and make a determination (572) regarding the integrity of the organization. If it is determined (558, 566 and 572) that the organization of the organized data has not maintained its integrity, it can be determined (560) that the integrity of the computing environment has been compromised. On the other hand, it is determined that the integrity of the organization is successfully verified or it is determined not to verify the integrity of the organization, the verification method 550 proceeds to verify (574) the integrity of the content of the organized data. If it is determined (576) that the content has not maintained its integrity, it is determined (560) that the computing environment has not maintained its integrity, and the verification method 550 ends. However, if it is determined (574) that the content has maintained its integrity, it is determined (578) that the computing environment has maintained its integrity. The verification method 550 can also end following a successful verification of the integrity of the computing environment.

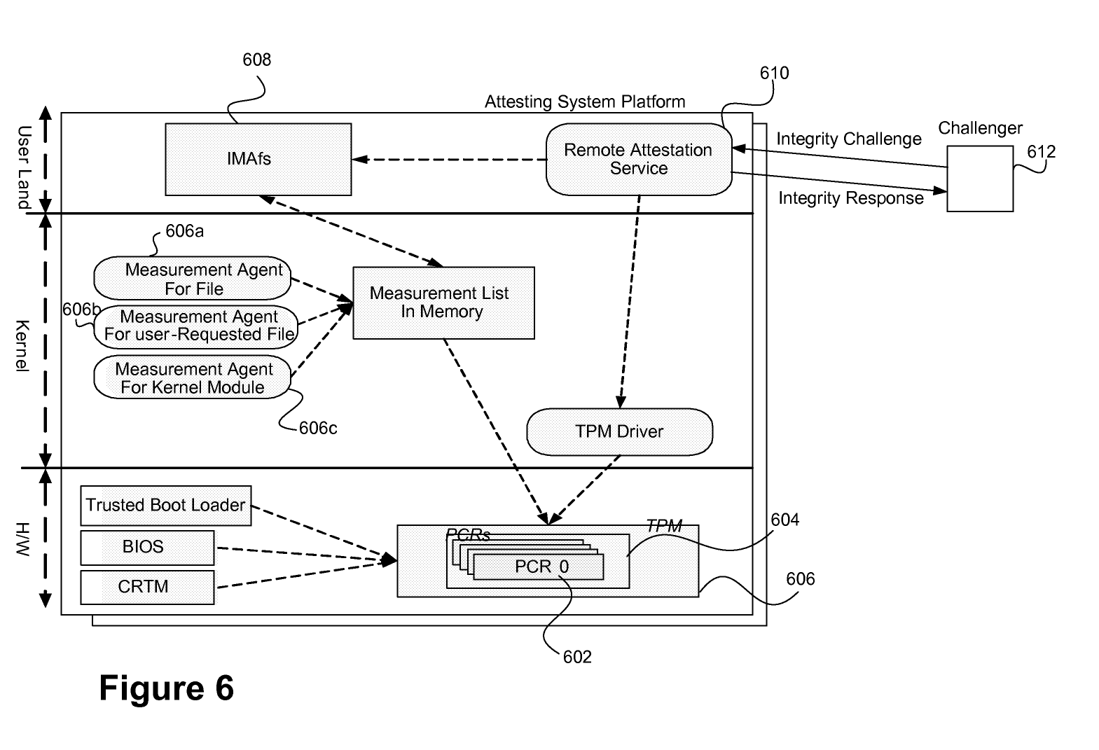

FIG. 6 depicts a computing system 600 that can use verifiable representative data to verify its integrity in accordance with one embodiment of the invention. Referring to FIG. 6, integrity values 602 can be securely stored by a Trusted Platform Module (TPM) 604 and used to effectively verify the integrity of various operating component including trusted boot loader and Basic Input Output System (BIOS). As will be known to those skilled in the art, various measurement agents 606 for files, user-requested files, and kernel modules can effectively operate in kernel space and communicate with Integrity Measurement Agents 608 for remote attestation services to respond to integrity challenges issued by a another system (challenger system) 612.

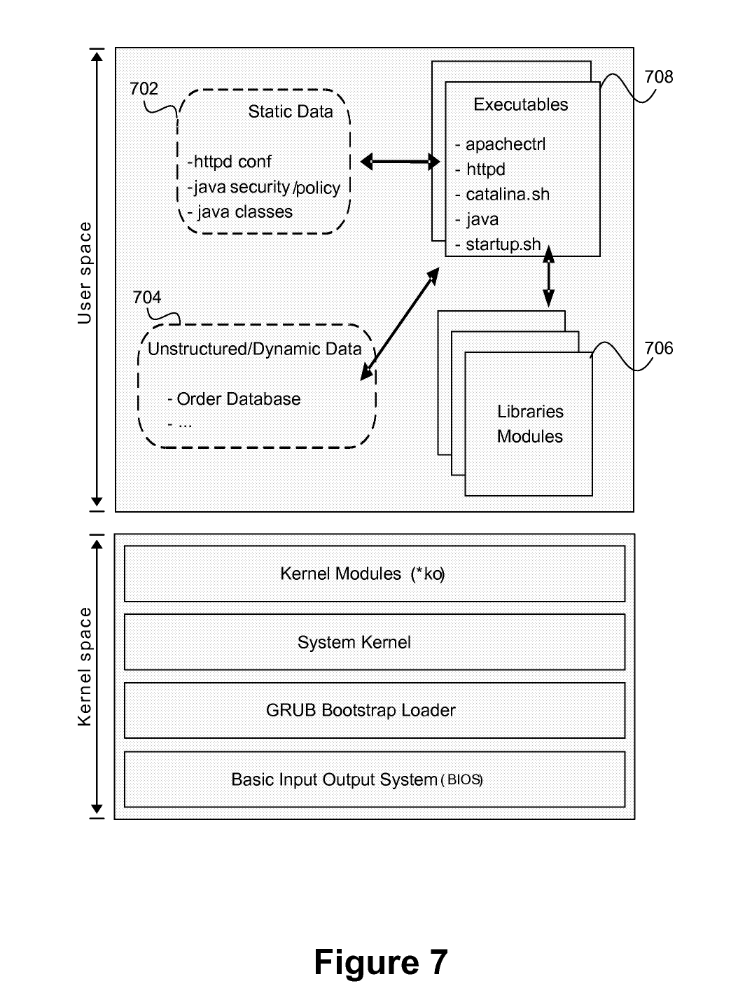

FIG. 7 depicts a computing environment 700 including content that can be represented by verifiable representative data in accordance with one embodiment of the invention. The computing environment 700 can, for example, represent a web server computing environment. Referring to FIG. 7, those skilled in the art will readily appreciate that various content including static data 702, unstructured/dynamic data 704 and library modules 706 and corresponding executables 708 can be effectively represented as verifiable representative data in accordance with the techniques of the invention described above.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of generating verifiable data for a computing environment, wherein said method comprises:
obtaining a representation of content of a computing environment, wherein the integrity of said computing environment can at least partially be assessed by verifying the integrity of said content, and wherein said representation of content effectively identifies one or more portions of said content, as one or more selected content portions selected for verification; and
generating, based on said representation of said content, verifiable representative data that includes said one or more selected portions of said content, wherein integrity of said verifiable representative data can be verified, thereby allowing integrity of said computing environment to be verified at least partly based on verification of integrity of said verifiable representative data.

2. The method of claim 1,
wherein said representation of content includes an organization for organizing a plurality of selected content portions of said content selected for verification in accordance with at least one organizational rule; and
wherein said generating generates an organized representation of said content.

3. The method of claim 2,
wherein said content includes a plurality of individual content components, and
wherein said organization effectively identifies a plurality of selected content components selected from said plurality of individual content components.

4. The method of claim 3, wherein said organization effectively identifies at least one selected content portion from each one of said plurality of individual content components.

5. The method of claim 3, wherein said plurality of individual content components include one or more of the following: one or more files, one or more configuration files, one or more text-based files, and one or more text files, one or more executable scripts, one or more configurable programs.

6. The method of claim 2,
wherein said organization effectively defines an arrangement for arranging said one or more selected portions of said content, and
wherein said generating generates said verifiable organized data such that said one or more selected portions are arranged in accordance with said arrangement, thereby effectively providing content in an organized manner for verification.

7. The method of claim 2, said method further comprises: defining said organization for said content.

8. The method of claim 7, wherein said method comprises: defining said representation as a template that can be used to effectively generate representative verifiable data for a plurality of instances of content including said content to be verified.

9. The method of claim 8,
wherein said plurality of instances of content belong to the same type or class of content, and
wherein said type and/or class include one or more of the following: configuration content, source code content, data, static data, dynamic data, module, and library module.

10. The method of claim 7, wherein said defining of said representation comprises:
selecting said one or more verifiable portions of said content as one or more security related portions of said content that are of security interest, thereby allowing said content to be effectively verified by verifying content that is of security interest.

11. The method of claim 7, wherein said defining of said representation further comprises:
not selecting at least one verifiable portions of said content that is not of security interest.

12. The method of claim 1, wherein said representation of content which effectively identifies said one or more selected portions of said content does not identify one or more other portions of said content, thereby allowing generating verifiable organized data which has a smaller size than the size of said content.

13. The method of claim 1, wherein said representation of content effectively identifies said one or more selected portions such that one or more portions of said content that are susceptible to change but not of relative security importance are not identified, thereby allowing generating verifiable representative data which is less likely to be changed as a result of change to content which is of a relatively lesser security importance.

14. The method of claim 1, wherein said representation of content effectively identifies a plurality of selectable content portions for a plurality of instances of content such that one or more of said plurality of selectable content portions can be selected for verification of a particular instance of said plurality of instances, thereby allowing selective generation of verifiable representative data and selective verification of data.

15. The method of claim 2, wherein said organization for said content to be verified includes and/or effectively defines one or more of the following:
a scheme, an organizational scheme, an organizational map, an organizational blue print, a schema, a conceptual schema, a conceptual data model, structural organization, semantics, one or more organizational rules, one or more parameters for verification, and one or more simplified parameters for verification.

16. The method of claim 2,
wherein said organization effectively identifies a plurality of selectable portions of said content which can be selected for verification of a particular instance of said content, and
wherein said method further comprises: receiving input in connection with a particular instance of said content, wherein said input is indicative of one or more of said plurality of selectable portions of content for selective verification.

17. The method of claim 2, wherein said content includes text and/or text-based content.

18. The method of claim 17, wherein said organization includes schema that effectively define at least a structure for said text and/or text-based content.

19. A method for generating a template suitable for generation of verifiable data for multiple instances content associated with a generic content category, wherein said method comprises:
obtaining representation of a generic content category, wherein said representation effectively identifies a plurality of selectable content and/or content portions that can be used to effectively represent multiple instances of said generic content category; and
generating, based on said representation of said generic content, a template that effectively includes said plurality of selectable content and/or content portions in a manner that allows a specific instance of verifiable organized data to be generated for a particular instance of said generic content category using said template by effectively selecting one or more of said selectable content and/or content portions for verification of said particular instance of content.

20. A method for generating organized verifiable data for content associated with a computing environment, wherein integrity of said computing environment can at least partially be assessed based on the assessment of the integrity of said organized verifiable data, and wherein said method comprises:
obtaining organizational data which effectively identifies a plurality of selected elements of said content selected for integrity verification and defines at least a structure for arranging said plurality of selected elements in accordance with an arrangement; and
generating, based on said structural data, structured verifiable content representative of said content, wherein said structured verifiable content includes said plurality of elements of said content arranged in accordance with said arrangement, thereby effectively providing structured verifiable content which is organized and can be verified based on said plurality of elements arranged in accordance with said arrangement.

21. The method of claim 20, wherein said method further comprises: defining said structure for said content to be verified.

22. The method of claim 21, wherein said method further comprises:
receiving said content; and
defining said structure for said content.

23. The method of claim 21, wherein said method further comprises:
obtaining structured content semantics representative of semantics for said structured verifiable content, wherein said structured content semantics includes at least one verifiable semantics rule; and
generating, based on said structured content semantics, structured and semantically verifiable content, thereby allowing said content to be verified by verifying said one or more verifiable structural elements and said at least one verifiable semantics rule.

24. The method of claim 21, wherein said one or more verifiable structural elements include and/or are associated with one or more verifiable parameters, thereby said structured verifiable content to verified by verifying said one or more verifiable parameters.

25. The method of claim 21, wherein said one or more verifiable parameters represent one or more simplified values corresponding to one or more actual values of said content.

26. A method for verifying integrity of computing environment, wherein said method comprises:
obtaining verifiable data that effectively identifies one or more selected portions of content of a computing environment, wherein said one or more selected portions of content are selected for verification and can effectively represent said content for verification;
verifying integrity of said verifiable organized data;
determining whether said computing environment has maintained its integrity or not based on said verifying of integrity of said verifiable organized data.

27. The Method of claim 26, wherein said method further comprises:
determining that said computing environment has not maintained its complete integrity when said verifying does not successfully verify the integrity of said verifiable organized data

28. The method of claim 27,
wherein said verifiable organized data represents said content of said computing environment; and
determining that said content has not maintained its integrity when said verifying does not successfully verify the integrity of said verifiable organized data;
verifies the integrity of said verifiable organized data; and
determining that said content has not maintained its integrity when said verifying does not successfully verify the integrity of said verifiable organized data.

29. A method for generating an integrity value for text-based content of a computing environment, said method comprising:
obtaining a scheme for said text-based content, wherein said scheme effectively defines one or more rules for said text-based content, wherein said one or more rules are consistent with at least one structured language suitable for providing structured content;
generating, based on said scheme, structured text-based data in said at least one structured language; and
determining an integrity value for said structured text-based data.

30. The method of claim 29, wherein said text-based content includes unstructured content.

31. The method of claim 30, wherein said text-based content includes one or more configuration files for configuring said computing environment.

32. The method of claim 29, wherein said method further comprises one or more of the following:
authenticating said integrity value using one or more authentication techniques; and
encrypting and/or storing said integrity value in a secure manner.

33. A method for verifying the integrity of data associated with a computing environment, wherein said method comprises:
obtaining structured text-based data expected to be in at least one structured language;
determining whether said structured text-based data is conforms to scheme of said at least one structured language; and
assessing the integrity of said computing environment at least partially based on whether said structured text-based data is consistent or not consistent with said at least one structured language;

34. The method of claim 33, wherein said at least one structured language is the XML language.

35. A computing system, wherein said computing system is operable to:
obtain a representation of content of a computing environment, wherein integrity of said computing environment can at least partially be assessed by verifying the integrity of said content, and wherein said representation of content effectively identifies one or more portions of said content, as one or more selected content portions of said content selected for verification; and
generate, based on said representation of said content, verifiable representative data that includes said one or more selected portions of said content, wherein integrity of said verifiable representative data can be verified, thereby allowing integrity of said computing environment to be verified at least partly based on verification of integrity of said verifiable representative data.

36. The computing system of claim 35, wherein said verifiable representative data is organized.

37. The computing system of claim 36, wherein said computing system is further operable to:
verify the integrity of said verifiable representative data based on organization of said verifiable representative data.

38. A computer readable medium including at least executable computer program code for generating verifiable data, wherein said computer readable medium includes:
executable computer program code for obtaining a representation of content of a computing environment, wherein the integrity of said computing environment can at least partially be assessed by verifying the integrity of said content, and wherein said representation effectively identifies one or more portions of said content, as one or more selected content portions of said content selected for verification; and
executable computer program code for generating, based on said representation of said content, verifiable representative data that includes said one or more selected portions of said content, wherein integrity of said verifiable representative data can be verified, thereby allowing integrity of said computing environment to be verified at least partly based on verification of integrity of said verifiable representative data.
